(19) United States
(12) Patent Application Publication
(10) Pub. No.: US 2026/0261292 A1
(43) Pub. Date: Sep. 3, 2026

(54) BEAMSPACE EIGEN PRECODING VIA SUBSPACE TRACKING

(71) Applicant: Telefonaktiebolaget LM Ericsson (publ), Stockholm (SE)

(72) Inventors: Amr EL-KEYI, Kanata (CA); Chandra BONTU, Nepean (CA)

(73) Assignee: Telefonaktiebolaget LM Ericsson (publ), Stockholm (SE)

(21) Appl. No.: 19/157,688

(22) PCT Filed: Feb. 22, 2023
(86) PCT No.: PCT/IB2023/051637

§ 371 Date: Aug. 19, 2025

(51) Int. Cl. H04B 7/0452; H04B 7/0456; H04B 7/06

(52) U.S. Cl. CPC H04B 7/0452; H04B 7/0456; H04B 7/06952

(57) ABSTRACT

According to some embodiments, a method performed by a network node comprises: receiving a physical uplink shared channel comprising a demodulation reference signal (DMRS) from a wireless device; estimating an uplink channel based on the DMRS; performing beamspace transformation and reduction on the estimated uplink channel; updating a subset of Eigen vectors of a wideband channel covariance matrix associated with the wireless device using the reduced beamspace uplink channel estimate via beamspace subspace tracking; pairing the wireless device with one or more additional wireless devices for MU-MIMO transmission based on the updated Eigen vectors of the wideband channel covariance matrix associated with the wireless device and spatial correlation with the updated Eigen vectors of the wideband channel covariance matrix associated with the additional wireless devices; and transmitting a MU-MIMO downlink transmission to the wireless device and the paired additional wireless devices.

### TECHNICAL FIELD

Embodiments of the present disclosure are directed to wireless communications and, more particularly, to reduced complexity beamspace multiple-user multiple-input multiple-output (MU-MIMO) Eigen precoding via subspace tracking.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In wireless communication networks, massive multiple input multiple output (MIMO) precoding can significantly improve the spectral efficiency of wireless communication systems (see H. Huh, G. Caire, H. C. Papadopoulos, and S. A. Ramprashad, “Achieving ‘massive MIMO’ spectral efficiency with a not-so-large number of antennas,” IEEE Transactions on Wireless Communications, vol. 11, no. 9, p. 3226-3239, September 2012). In MU-MIMO operation, two or more user equipment (UE) share the same time/frequency resources. Several parallel data streams are transmitted simultaneously, one for each UE. The UE feeds back a quantized version of the observed channel so that a base station can schedule MU-MIMO mode terminals with good channel separation. Optimal massive MIMO precoding requires acquisition of instantaneous downlink channel state information (CSI) for optimal user selection and precoding design.

In time division duplex (TDD)-based communication systems, downlink CSI can be acquired due to channel reciprocity by using the reference signals transmitted by the user equipment (UE) in uplink transmissions. For example, in fourth generation (4G) and fifth generation (5G) systems, CSI can be acquired using sounding reference signals (SRS) that are transmitted from the user equipment (UE) and can be configured to span the full transmission bandwidth to provide detailed CSI to the base station.

SRS capacity in 4G and 5G systems, however, is limited and only a finite number of SRS resources can be assigned at a given uplink transmission slot. As a result, using the second-order statistics, i.e., covariance matrix, of the channel in designing massive MIMO precoding algorithms has been proposed.

One example is the Grid of Beams (GoB) algorithm proposed for MIMO precoding (see S. Savazzi, M. Nicoli, and M. Sternad, “A Comparative Analysis of Spatial Multiplexing Techniques for Outdoor MIMO-OFDM Systems with a Limited Feedback Constraint,” IEEE Transactions on Vehicular Technology, vol. 58, no. 1, pp. 218-230, January 2009). The GoB algorithm employs a set of fixed predetermined precoders (beams) for downlink beamforming that focus downlink transmission in the direction of the target UE. Alternately, the precoders can also be determined based on feedback from the UE, e.g., using the precoding matrix indicator (PMI) associated with Type 1 codebook feedback.

MU-MIMO precoding using signal space tracking has also been proposed for active antenna systems (see A. El-Keyi, S. Bergman and Y. Qiang, “Adaptive downlink multi-user multiple-input multiple-output (MU-MIMO) precoding using uplink signal subspace tracking for active antenna systems (AAS)”. Patent 20210234580, 29 Jul. 2021). This proposal tracks multiple Eigen vectors and Eigen vectors of the uplink covariance matrix comprising the signal space using the uplink channel estimates. The tracked estimates are used to compute a measure of the MU-MIMO interference leakage for UE pairing as well as designing MU-MIMO precoders by projection on the complement of the signal space of the paired users.

There currently exist certain challenges. For example, existing SRS-based solutions for MU-MIMO precoding suffer from limited SRS capacity especially when the UE mobility is high and channel estimates acquired from uplink SRS transmissions must be frequently updated to prevent performance degradation due to outdated channel estimates. On the other hand, GoB-based MU-MIMO precoding techniques suffer from the absence of efficient multiuser MIMO interference suppression and have limited capability of spatial multiplexing.

The algorithms developed in 20210234580 use the full signal space for MU-MIMO pairing decisions and precoder calculation using the full-dimension antenna-space channel estimates. In particular, an interference leakage metric is computed using all the tracked Eigen values and Eigen vectors is computed and used for pairing decisions. Furthermore, the precoder of each paired UE is computed separately by projecting the Eigen vectors of the UE on the complement of the combined tracked signal space of the UEs paired with this user. This increases the complexity of MU-MIMO pairing and precoding calculation.

### SUMMARY

As described above, certain challenges currently exist with sounding reference signal (SRS)-based solutions for multiple-user multiple-input multiple-output (MU-MIMO) precoding. Certain aspects of the present disclosure and their embodiments may provide solutions to these or other challenges. For example, particular embodiments use the second-order statistics of the uplink channel acquired through iterative estimation of a subset of the Eigen vectors of the uplink wideband covariance matrix to design MU-MIMO user selection and precoding techniques.

The Eigen vectors may be directly estimated using uplink channel estimates obtained using demodulation reference signals (DMRS) transmitted by a user equipment (UE) during its uplink data transmission. Thus, the need for detailed channel estimates is eliminated and the algorithm is not affected by the limited SRS capacity of the system.

Particular embodiments directly estimate the Eigen vectors without the need for explicit estimation of the uplink covariance matrix by using subspace tracking via projection approximation. Furthermore, particular embodiments use beamspace reduction of the channel estimates to reduce the computational complexity of tracking the Eigen vectors. Particular embodiments use a low-complexity orthogonality test between a subset of the tracked Eigen vectors of different UEs. Furthermore, the MU-MIMO precoders of the paired UEs are jointly calculated using the tracked Eigen vectors of the paired UEs using the minimum mean square error (MMSE) design criterion.

Particular embodiments are applicable to generic MU-MIMO precoding between users with detailed channel state information (CSI) obtained from SRS transmissions and users with Eigen vectors-based CSI where MU-MIMO orthogonality testing between the Eigen vectors and the channel estimates may be employed for pairing decisions. In addition, joint MU-MIMO MMSE precoding may be used for the paired users using the Eigen vectors and the channel estimates of the paired users.

In general, particular embodiments use beamspace channel estimates obtained from uplink DMRS transmitted by the UEs during uplink data transmission on some subbands to track a subset of the Eigen vectors of the uplink covariance matrix. Some embodiments estimate the Eigen vectors directly using the beamspace uplink channel estimates without the need for explicit estimation of the uplink covariance matrix. Particular embodiments estimate the Eigen vectors of the wideband covariance matrix of the channel associated with the base station antennas with the same polarization only. Co-phasing is used to construct the full dimension Eigen vectors.

Some embodiments use the tracked Eigen vectors to perform user selection and downlink precoding for downlink MU-MIMO transmission. Some embodiments perform MU-MIMO user selection using a low-complexity wideband spatial orthogonality test between a subset of the per-polarization Eigen vectors of MU-MIMO candidate users.

Some embodiments construct the MU-MIMO downlink precoders using a subset of the per-polarization Eigen vectors of the selected users using the MMSE design criterion. Particular embodiments perform joint MU-MIMO pairing and precoding between reciprocity-aided transmission (RAT) users with detailed CSI comprising channel estimates for different subbands and users with Eigen vectors-based CSI. The full dimension Eigen vectors of the non-RAT users and the channel estimates of the RAT users are used for orthogonality testing as well as for calculating the MMSE precoders of different subbands.

According to some embodiments, a method is performed by a network node for MU-MIMO transmission. The method comprises: receiving a PUSCH comprising a DMRS from a first wireless device; estimating an uplink channel from the first wireless device based on the received DMRS; performing beamspace transformation and reduction on the estimated uplink channel; updating a subset of Eigen vectors of a wideband channel covariance matrix associated with the first wireless device using the reduced beamspace uplink channel estimate via beamspace subspace tracking; pairing the first wireless device with one or more additional wireless devices for MU-MIMO transmission based at least on the updated Eigen vectors of the wideband channel covariance matrix associated with the first wireless device and spatial correlation with the updated Eigen vectors of the wideband channel covariance matrix associated with the one or more additional wireless devices; and transmitting a MU-MIMO downlink transmission to the first wireless device and the paired one or more additional wireless devices.

In particular embodiments, the method further comprising generating a precoding matrix for the MU-MIMO transmission based at least on the updated Eigen vectors of the wideband channel covariance matrix associated with the paired wireless devices. Transmitting the MU-MIMO downlink transmission uses the precoding matrix.

In particular embodiments, beamspace reduction selects beams using one of a fixed number of active beam selection, a collective power in active beams selection, and a threshold-based beam selection.

In particular embodiments, the beamspace subspace tracking is based on an estimated instantaneous beamspace per-polarization covariance matrix and constructing full dimension Eigen vectors via cophasing the Eigen vectors of the per polarization covariance matrix. The beamspace subspace tracking may use projection approximation subspace tracking with deflation (PASTd). The beamspace subspace tracking may further comprise orthogonalizing Eigen vectors that were updated using PASTd.

In particular embodiments, pairing the first wireless device with one or more additional wireless devices is further based on SRS based channel estimates associated with each of the one or more additional wireless devices. Pairing the first wireless device with one or more additional wireless devices may be further based on a transmission priority associated with each of the one or more additional wireless devices.

In particular embodiments, generating the precoding matrix is further based on Eigen vectors of the wideband channel covariance matrix associated with each of the one or more additional wireless devices. Generating the precoding matrix may be further based on SRS based channel estimates associated with each of the one or more additional wireless devices.

According to some embodiments, a network node network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments eliminate the need for detailed channel estimates where MU-MIMO user selection and precoding is not restricted by the limited SRS capacity of the system. Particular embodiments use reduced dimension beamspace uplink channel estimates for tracking the Eigen vectors via projection approximation with reduced computational complexity.

Particular embodiments use the channel estimates to track a subset of the Eigen vectors of the per-polarization uplink covariance matrix. The tracked Eigen vectors may be used for both MU-MIMO user selection and precoding design.

Particular embodiments facilitate joint MU-MIMO precoding between RAT users with detailed channel estimates obtained from SRS and users with Eigen-based CSI.

The performance of particular embodiments provides significant gain in downlink cell throughput compared to GoB-based MU-MIMO user selection and precoding.

Particular embodiments improve throughput compared to MU-MIMO algorithms that use instantaneous channel estimates acquired from periodic SRS transmission in scenarios with high UE mobility. In these scenarios, the UE mobility causes the channel estimates to be outdated as the limited SRS capacity of the system prevents their frequent update. In contrast, the MU-MIMO Eigen beamforming of particular embodiments uses the information in the covariance matrix that changes at a slower rate with UE mobility than the instantaneous channel information acquired from SRS transmissions.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating a uniformly spaced two-dimensional polarized antenna array;

FIG. 2 is a block diagram illustrating an example of a beamspace multiple-user multiple-input multiple-output (MU-MIMO) Eigen precoding algorithm;

FIG. 3 is a flowchart illustrating an example MU-MIMO pairing algorithm;

FIG. 4 is a graph illustrating average downlink cell throughput versus number of users;

FIG. 5 is a graph illustrating average number of physical downlink shared channel (PDSCH) layers versus number of users;

FIG. 6 is a graph illustrating average downlink cell throughput versus user equipment (UE) speed;

FIG. 7 is a graph illustrating average downlink cell throughput versus number of active beams;

FIG. 8 is a graph illustrating downlink cell throughput versus number of sounding reference signal (SRS) resources per cell

FIG. 9 illustrates an example communication system, according to certain embodiments;

FIG. 10 illustrates an example user equipment (UE), according to certain embodiments;

FIG. 11 illustrates an example network node, according to certain embodiments; and

FIG. 12 illustrates a method performed by a network node, according to certain embodiments.

### DETAILED DESCRIPTION

As described above, certain challenges currently exist with sounding reference signal (SRS)-based solutions for multiple-user multiple-input multiple-output (MU-MIMO) precoding. Certain aspects of the present disclosure and their embodiments may provide solutions to these or other challenges. For example, particular embodiments use the second-order statistics of the uplink channel acquired through iterative estimation of a subset of the Eigen vectors of the uplink wideband covariance matrix to design MU-MIMO user selection and precoding techniques. The Eigen vectors may be directly estimated using uplink channel estimates obtained using demodulation reference signals (DMRS) transmitted by a user equipment (UE) during its uplink data transmission. Thus, the need for detailed channel estimates is eliminated and the algorithm is not affected by the limited SRS capacity of the system.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

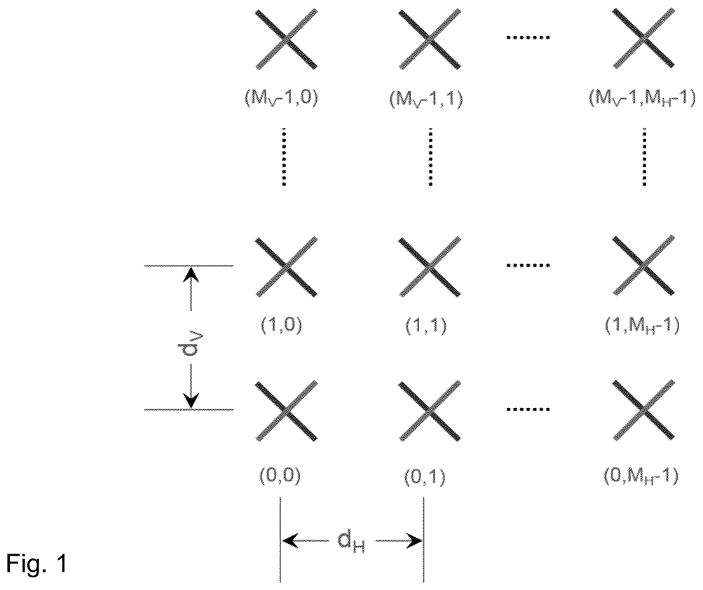

Particular embodiments may be described with respect to a base station employing an M-element 2-dimensional polarized array. An example antenna is illustrated in FIG. 1.

FIG. 1 is a block diagram illustrating a uniformly spaced two-dimensional polarized antenna array. Let M_{V} and M_{H} denote the number of rows and columns of the 2-dimensional antenna array, respectively, i.e., the total number of antenna elements is given by M=2M_{V}M_{H}. The M×1 vector hᵢ(f, t) contains the coefficients of the uplink channel from one of the transmission ports of UE i to the base station at time instant t and frequency subband f as

$${h}_{i} ( f , t ) = {[ {h}_{i}^{{( 0 )}^{T}} ( f , t ) , {h}_{i}^{{( 1 )}^{T}} ( f , t ) ]}^{T} ,$$

where (.)^{T}, (.)^{H}, and (.)* denote the transpose, Hermitian transpose, and complex conjugate operators, respectively, and

$${h}_{i}^{( p )} ( f , t )$$

is the M_{V}M_{H}×1 vector containing the coefficients of the channel associated with the base station antennas with polarization p. The channel estimates are available at the base station using the uplink reference signals transmitted from the UEs during their uplink transmissions, e.g., from a demodulation reference signal (DMRS) associated with physical uplink shared channel (PUSCH) transmissions.

In time division duplex (TDD) systems where channel reciprocity can be assumed, the downlink channel estimates can be acquired from uplink channel estimates. The channel estimates can be used for determining the precoders for multiuser downlink transmission.

Optimal downlink MU-MIMO transmission requires acquisition of instantaneous downlink channel information. However, non-outdated instantaneous channel estimates might not be available at the base station for all the subbands because the uplink transmissions from the UEs are sporadic, depending on the traffic profile of the radio-bearer. As a result, downlink MU-MIMO pairing and precoding algorithms can use the information in the wideband channel covariance matrix, e.g., the Eigen vectors, that change at a much slower rate than the rate of change of the channel coefficients.

Particular embodiments described herein include reduced-complexity MU-MIMO user selection and precoding algorithms that use the Eigen vectors of the estimated downlink channel covariance matrix.

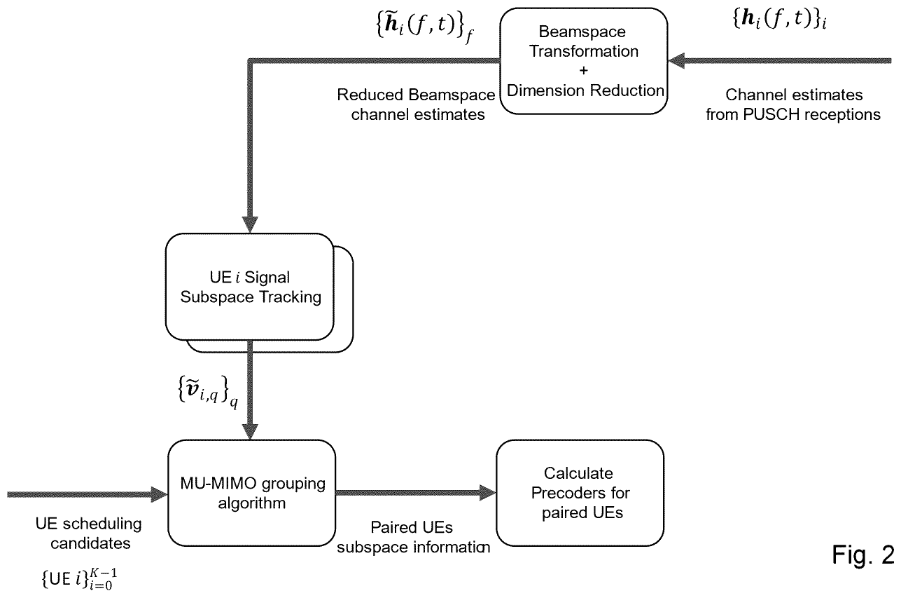

FIG. 2 is a block diagram illustrating an example of a downlink MU-MIMO Eigen precoding algorithm. The algorithm employs a subspace tracking block for each UE that estimates the signal subspace information, i.e., the dominant Eigen vectors, of its downlink channel covariance matrix. Each subspace tracking block uses the reduced beamspace channel estimates obtained from the uplink reference signals of its associated UE. The signal subspace information of the scheduling UE candidates is used to decide the paired MU-MIMO UEs that will be scheduled as well as to compute the MU-MIMO precoding vectors of the paired UEs. In the next subsections, we will describe each block of the system.

Particular embodiments include beamspace transformation and dimension reduction. Massive MIMO channels are expected to have low rank because communication occurs in a low-dimensional subspace of the high-dimensional spatial signal space (see A. M. Sayeed, “Deconstructing multiantenna fading channels,” IEEE Transactions on Signal Processing, vol. 50, no. 10, p. 2563-2579, 2002). Beamspace transformation has been proposed to use the reduced rank of the signal subspace where a set of orthogonal beams are used to approximate the eigenvectors of the channel covariance matrix. As a result, beamspace transformation of channel estimates reduces the number of significant elements of the channel vector, and thus reduces the complexity of subsequent signal processing operations (see A. Sayeed and J. Brady, “Beamspace MIMO for high-dimensional multiuser communication at millimeter-wave frequencies,” in IEEE Global Communications Conference (GLOBECOM), 2013).

Two-dimension spatial discrete Fourier transform (2D-SDFT) beamspace basis have been widely used for two-dimensional polarized arrays because they match the spatial signature of propagating plane waves. For the two-dimensional polarized array shown in FIG. 1, the M×M matrix containing the basis of the 2D-SDFT beamspace transformation is given by B=I₂⊗D_{H}⊗D_{V}, where I_{K} denotes the K×K identity matrix, D_{H} and D_{V} are M_{H}×M_{H} and M_{V}×M_{V} DFT matrices, i.e., the (m, k) element of D_{X} is given by

$$\frac{1}{\sqrt{{M}_{X}}} {e}^{j \frac{2 π mk}{{M}_{X}}}$$

where m, k=1, . . . , M_{X}.

The channel measurements are converted to beamspace using the transformation matrix B and dimension reduction is applied. Let \tilde{h}ᵢ(f, t) denote the M×1 reduced beamspace channel vector associated with UE i, i.e., \tilde{h}ᵢ(f, t)=Sᵢ B^{H} hᵢ(f, t), and dimension reduction is applied to produce the sparse channel vectors where Sᵢ is a diagonal M×M matrix whose jth diagonal element is equal to 1 if the jth beam is active and 0 if the beam is inactive.

Several criteria can be used for selection of active beams used in dimension reduction of the UE channel. The selection criteria may be based on the channel power where the instantaneous power per beam for the i-th UE is computed from the channel estimates, i.e., pᵢ(b, t)=Σ_{f}|[B^{H}hᵢ(f, t)]_{b}|², where |.| denotes the magnitude of a complex number, [x]_{b} denotes the bth component of the vector x and the summation is over the subbands for which channel estimates are available for UE i at time t. Let Aᵢ(t) denote the set containing the active beams for the i-th UE. The active beams can be selected using any of the following methods.

One method is the fixed number of active beams method. This method selects a fixed number of beams that yield the maximum power sum Σ_{b∈A}_{ᵢ}₍ₜ₎pᵢ(b, t).

Another method is the collected power in active beams method. This method selects the minimum number of beams that have a total power greater than a fraction κ of the total power in all beams, i.e., the set of active beams is the solution to the following optimization problem min |Aᵢ(t)| subject to Σ_{b∈A}_{ᵢ}₍ₜ₎pᵢ(b, t)>κΣ_{b}pᵢ(b, t), where |Aᵢ(t)| denotes the cardinality of the set Aᵢ(t).

Another method is the threshold based beam activation method. This method selects the beams that have a power value greater than a threshold r of the total power, i.e., the set of selected active beams is given by Aᵢ(t)={b|pᵢ(b, t)>τΣ_{b}pᵢ(b, t)}.

Some embodiments include beamspace subspace tracking. The base station iteratively estimates and tracks a subset of the Eigen vectors of the wideband covariance matrix of the uplink channel of each UE using the reduced beamspace uplink channel estimates as shown in FIG. 2. Particular embodiments use the polarized array structure shown in FIG. 1 and assume that the wideband covariance matrix of the beamspace channel coefficients associated with each set of polarized antennas is identical, i.e.,

$$E \{ {h}_{i}^{( 0 )} ( f , t ) {h}_{i}^{{( 0 )}^{H}} ( f , t ) \} = E \{ {h}_{i}^{( 1 )} ( f , t ) {h}_{i}^{{( 1 )}^{H}} ( f , t ) \} = {R}_{i}^{( p )} ( t ) ,$$

where Rᵢ(t) is the

$$\frac{M}{2} \times \frac{M}{2}$$

wideband per-polarization covariance matrix of the antenna space channel of UE i. Furthermore, instead of tracking the Eigen vectors of the antenna-space covariance matrix Rᵢ(t), particular embodiments track the Eigen vectors of the beamspace wideband per-polarization covariance matrix

$${\tilde{R}}_{i}^{( p )} ( t ) = {B}^{{( p )}^{H}} {R}_{i}^{( p )} ( t ) {B}^{( p )} ,$$

where B^{(p)}=D_{H}⊗D_{V} is the

$$\frac{M}{2} \times \frac{M}{2}$$

per-polarization 2D-SDFT beamspace transformation matrix.

Some embodiments include beamspace covariance matrix singular value decomposition. In this embodiment, the instantaneous beamspace per-polarization covariance matrix is explicitly estimated and used to update a filtered version of the covariance matrix. The beamspace channel estimate \tilde{h}ᵢ(f, t) may be written as

$${\tilde{h}}_{i} ( f , t ) = {[ {\tilde{h}}_{i}^{{( 0 )}^{T}} ( f , t ) , {\tilde{h}}_{i}^{{( 1 )}^{T}} ( f , t ) ]}^{T} ,$$

where

$${\tilde{h}}_{i}^{{( p )}^{T}} ( f , t )$$

is the beamspace channel estimate associated with base station antennas with polarization p. Thus, when new channel estimates {\tilde{h}ᵢ(f, t)}_{f} are available for UE i, the

$$\frac{M}{2} \times \frac{M}{2}$$

per-polarization instantaneous wideband covariance matrix at time instant t is computed as

$${\tilde{R}}_{i} ( t ) = \frac{1}{2 {N}_{i , f} ( t )} {\sum }_{p = 0 , 1} {\sum }_{f} {\tilde{h}}_{i}^{( p )} ( f , t ) {\tilde{h}}_{i}^{{( p )}^{H}} ( f , t ) ,$$

where N_{i,f} is the number of subbands for which channel estimates are available for UE i at time t. The filtered wideband per-polarization covariance matrix R̅ᵢ(t) is updated using the estimated instantaneous covariance matrix \tilde{R}ᵢ (t) as R̅ᵢ(t)=(1−α) R̅ᵢ(t)+α\tilde{R}ᵢ(t), where 0<α<1 is the forgetting factor. Note that R̅ᵢ(t) is initialized using the first estimate of the instantaneous covariance matrix. The singular value decomposition (SVD) may be used to to estimate a fraction

$$Q < \frac{M}{2}$$

of the Eigen vectors of the covariance matrix R̅ᵢ(t) yielding the

$$\frac{M}{2} \times 1$$

dimensional Eigen vectors

$${\{ {\tilde{v}}_{i , q} ( t ) \}}_{q = 0}^{Q - 1} ,$$

where \tilde{v}_{i,q}(t) is the Eigen vector associated with the qth strongest Eigen value.

Some embodiments include beamspace projection approximation subspace tracking. In these embodiments, the projection approximation subspace tracking algorithm with deflation (PASTd) may be used for tracking the signal space with small computational complexity without explicit estimation of the covariance matrix (see B. Yang, “Projection approximation subspace tracking,” IEEE Transactions on Signal Processing, vol. 43, pp. 95-107, January 1995). Particular embodiments use the channel measurements {\tilde{h}ᵢ(f, t)}_{f} to update the Eigen vectors

$${\{ {\tilde{v}}_{i , q} ( t ) \}}_{q = 0}^{Q - 1} .$$

Let 0<β<1 denote the forgetting factor of the PASTd algorithm that is intended to ensure that channel measurements in the past are downweighed. To simplify the presentation, this description drops the dependence of the covariance matrix and Eigen vectors on time t. In particular embodiments, the beamspace subspace tracking algorithm iteratively estimates a fraction

$$Q < \frac{M}{2}$$

Eigen vectors

$${\{ {\tilde{v}}_{i , q} \}}_{q = 0}^{Q - 1} .$$

The algorithm is initialized by setting the exponentially weighted estimated Eigen values

$${\{ {γ}_{i , q} = \frac{2}{M} \}}_{q = 0}^{Q - 1}$$

and the estimated Eigen vectors

$${\{ {\tilde{v}}_{i , q} = {e}_{q} \}}_{q = 0}^{Q - 1} ,$$

where e_{q} is the qth column of the

$$\frac{M}{2} \times \frac{M}{2}$$

identity matrix. The algorithm uses the per-polarization reduced beamspace channel estimates of UE i from all subbands with available channel estimates to update the estimated Eigen vectors. Thus, when new channel estimates {\tilde{h}ᵢ(f, t)}_{f} are available for UE i, the estimated Eigen vectors

$${\{ {\tilde{v}}_{i , q} \}}_{q = 0}^{Q - 1}$$

are updated as follows

```
  □ Initialize the PASTd eigen vectors v_{i,q} = \tilde{v}_{i,q} for q = 0, ... , Q − 1
  □ For each subband f with available channel estimates
            ○ For p = 0, 1
                $Compute the \frac{M}{2} \times 1 normalized measurement vector {u}_{i , 0} = \frac{{\tilde{h}}_{i}^{( p )} ( f , t )}{‖ {\tilde{h}}_{i}^{( p )} ( f , t ) ‖}$
                □ For q = 0, ... , Q − 1
                        $Compute the inner product {y}_{i , q} = {v}_{i , q}^{H} {u}_{i , q}$
                        □ Update the exponentially weighted eigenvalue γ_{i,q} =
                            βγ_{i,q} + |γ_{i,q}|
                        $Compute the \frac{M}{2} \times 1 innovation vector {r}_{i , q} = {u}_{i , q} - {v}_{i , q} {y}_{i , q}$
                        $Update the estimate of the qth eigen vector {v}_{i , q} = {v}_{i , q} + {r}_{i , q} \frac{{y}_{i , q}^{*}}{{γ}_{i , q}}$
                        □ Compute deflated measurement for next update u_{i,q+1} =
                            u_{i,q} − v_{i,q}y_{i,q}
                □ End for q
            ○ End for p
□ End for each subband f
$Use Gram - Schmidt orthogonalization to get the updated eigen vectors {\{ {\tilde{v}}_{i , q} \}}_{q = 0}^{Q - 1}$
      $from {\{ {v}_{i , q} \}}_{q = 0}^{Q - 1}$
```

The computational complexity of the above PASTd algorithm for each available channel estimate \tilde{h}ᵢ(f, t) is given by 4MQ+4Q+3|Aᵢ(t)|−2M multiplications, 4MQ+|Aᵢ(t)|−2M additions, and Q+2 divisions where |Aᵢ(t)| is the number of active beams for UE i. Because the PASTd algorithm does not guarantee the orthogonality of the updated Eigen vectors

$${\{ {\tilde{v}}_{i , q} \}}_{q = 0}^{Q - 1} ,$$

Gram-Schmidt orthogonalization is performed after processing all the channel estimates of UE i obtained from different subbands to orthogonalize the updated estimates of the Eigen vectors.

Some embodiments include a MU-MIMO grouping algorithm. Given the set of candidate UEs for MU-MIMO scheduling, the grouping algorithm selects a subset of the UEs for MU-MIMO co-scheduling based on the tracked subspace information of the candidate UEs. The selection is done in the shared domain where the information of all the candidate UEs can be jointly processed.

Let Lᵢ denote the number of layers that will be transmitted to UE i in the downlink MU-MIMO transmission. The number of layers may be selected for each UE by following the UE reported rank. The Eigen vector correlation metric for testing whether UEs i and j can be paired together is defined as

$${ρ}_{\tilde{v}}^{( i , j )} = {\sum }_{u = 0}^{⌈ \frac{{L}_{i}}{2} ⌉ - 1} {\sum }_{v = 0}^{⌈ \frac{{L}_{v}}{2} ⌉ - 1} {\vert \begin{matrix}{\tilde{v}}_{i , u}^{H} & {\tilde{v}}_{j , v}\end{matrix} \vert}^{2} ,$$

where ┌x┐ denotes the smallest integer greater than or equal to x. Note that

$$⌈ \frac{{L}_{i}}{2} ⌉$$

eigen vectors are used for UE i when computing the correlation metric because each eigen vector is used to compute the precoders for two layers of the downlink transmission using polarization cophasing, as described in more detail below. The two UEs i and j are pairable if

$${ρ}_{\tilde{v}}^{( i , j )} < {γ}_{ρ} ,$$

where γ_{ρ} is a predetermined threshold. In contrast with the channel orthogonality metric, the metric

$${ρ}_{\tilde{v}}^{( i , j )}$$

is evaluated from wideband channel information and does not need averaging over subbands.

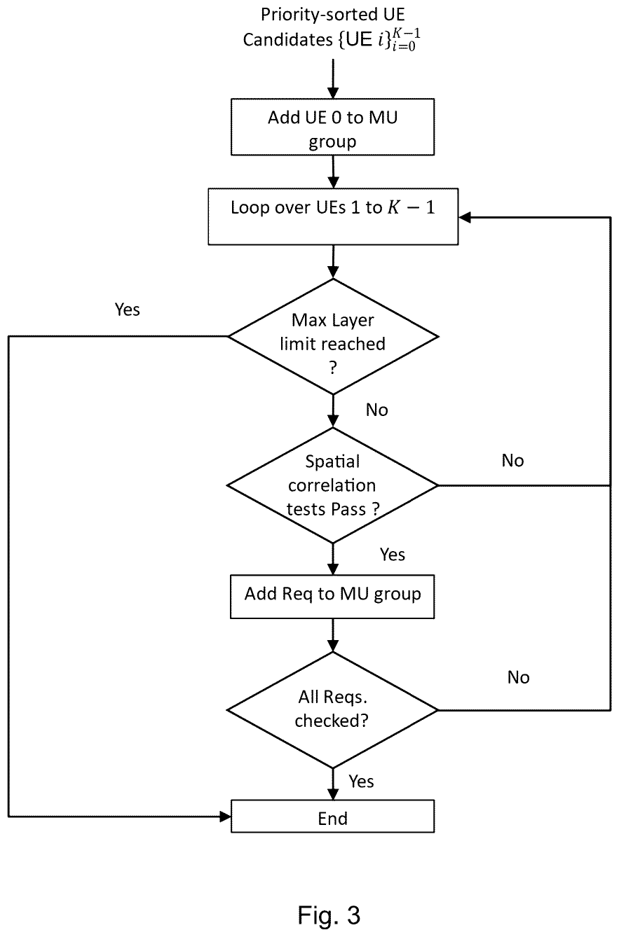

FIG. 3 is a flowchart illustrating an example algorithm for performing MU-MIMO pairing decisions. The set of candidate UEs for MU-MIMO scheduling

$${\{ UE i \}}_{i = 0}^{K - 1}$$

are ordered descendingly based on their scheduling priority. The proposed iterative pairing algorithm starts by adding the UE with the highest priority, i.e., UE 0, to the MU-MIMO group. At each iteration the UE with the next highest priority is considered. The UE is added to the MU-MIMO group if the total number of MU-MIMO layers does not exceed the the maximum number of layers that can be paired in an MU-MIMO transmission Lₘₐₓ. Furthermore, the correlation metric between the UE and each of the UEs that are already paired has to be lower than the predetermined threshold for the UE to be added to the MU-MIMO group.

The set containing the indices of the MU-MIMO co-scheduled UEs as is defined as Ψ. The set is initialized as Ψ={0}. The algorithm can be written as the following steps.

```
□  For i = 1, 2, ... , K − 1
        ○ If Lᵢ + E_{j∈Ψ} Lⱼ < Lₘₐₓ
            □ For each j ∈ Ψ
                    $If {ρ}_{\tilde{v}}^{( i , j )} \geq {γ}_{ρ} break and go to the next i$
            □ End For
            □ All tests passed. Thus, add UE i to the MU-MIMO group, i.e., Ψ =
                Ψ ∪ {i}.
        ○ End If
□ End for i
```

Some embodiments include MU-MIMO precoder calculation. The Q tracked Eigen vectors

$${\{ {\tilde{v}}_{i , q} \}}_{q = 0}^{Q - 1}$$

for UE i are used to construct the 2Q×M directional beamspace information matrix for UE i at subband f by co-phasing the per-polarization estimated eigen vectors, i.e.,

$${\tilde{U}}_{i} ( f ) = \frac{1}{\sqrt{2}} [ \begin{matrix}[ \begin{matrix}1 & {φ}_{1} ( f ) \\ 1 & - {φ}_{1} ( f )\end{matrix} ] ⊗ {\tilde{v}}_{1 , 0}^{T} \\ ⋮ \\ [ \begin{matrix}1 & {φ}_{1} ( f ) \\ 1 & - {φ}_{1} ( f )\end{matrix} ] ⊗ {\tilde{v}}_{1 , Q - 1}^{T}\end{matrix} ]$$

where ⊗ denotes the Kronecker product operator,

$${φ}_{i} ( f ) = {e}^{\sqrt{- 1} \frac{π κ ( f )}{2}}$$

is the co-phasing factor, and κ(f)∈{0, 1, 2, 3} may be used to introduce frequency selectivity in the design of the precoder. Alternately, a fixed co-phasing factor, e.g., κ(f)=0, may be used to design wideband MU-MIMO precoding with reduced computational complexity.

As an example, assume that UEs 0, 1, . . . , K−1 are paired in a downlink MU-MIMO transmission. The M×L precoding matrix (in beamspace domain) for downlink transmission may be designed using the MMSE design criterion as \tilde{W}(f)=\tilde{V}^{H} (f)(\tilde{V}(f)\tilde{V}^{H}(f)+δ²I_{L})⁻¹, where L denotes the total number of MU-MIMO layers, i.e.,

$$L = {\sum }_{i = 0}^{K - 1} {L}_{i} ,$$

the L×M combined directional information matrix \tilde{V}(f) is given by

$$\tilde{V} ( f ) = [ \begin{matrix}{\tilde{V}}_{0} ( f ) \\ ⋮ \\ {\tilde{V}}_{K - 1} ( f )\end{matrix} ] ,$$

the Lᵢ×M matrix \tilde{V}ᵢ(f) is constructed by selecting the first Lᵢ rows of the matrix Ũᵢ(f), and δ² denotes the diagonal loading factor.

The normalized precoding matrix \tilde{W}_{N}(f) is obtained from \tilde{W}(f) by first normalizing each column of \tilde{W}(f) such that its norm is

$$\frac{1}{\sqrt{L}} .$$

Afterwards, per antenna power constraints are enforced via linear backoff to avoid null distortion. Finally, the precoding matrix is transformed to antenna space using the Beamspace basis matrix, i.e., W_{N}(f)=B \tilde{W}_{N}(f) and the M×L matrix antenna space precoding matrix W_{N}(f) is used for precoding the downlink transmission of the L MU-MIMO layers.

Some embodiments include joint MU-MIMO Eigen/RAT precoding (generic MU precoding). Particular embodiments facilitate MU-MIMO transmission between users with detailed channel estimates, e.g., obtained from SRS transmissions, and users with Eigen vectors-based CSI. Let \tilde{h}_{i,j}(f, t) denote the M×1 vector containing the normalized coefficients of the beamspace uplink channel estimates from SRS transmission port j of UE i to the base station at time instant t and frequency subband f. The normalization is done such that ∥\tilde{h}_{i,j}(f, t)∥=1.

For simplicity, assume two users. For UE 0, detailed beamspace normalized channel estimates

$${\{ {\tilde{h}}_{0 , j} ( f , t ) \}}_{j = 0}^{{N}_{S R S} - 1}$$

are available for all SRS ports where N_{SRS} is the number of SRS ports of UE 0. Only the beamspace channel measurements {\tilde{h}₁(f, t)}_{f} are available UE 1 for some subbands through DMRS and are used to track the Eigen vectors

$${\{ {\tilde{v}}_{1 , q} ( t ) \}}_{q = 0}^{Q - 1}$$

and construct the 2Q×M directional beamspace information matrix Ũ₁(f, t) for UE 1 at subband f by co-phasing the per-polarization estimated eigen vectors using the algorithm described above, i.e.,

$${\tilde{U}}_{i} ( f , t ) = \frac{1}{\sqrt{2}} [ \begin{matrix}[ \begin{matrix}1 & {φ}_{1} ( f ) \\ 1 & - {φ}_{1} ( f )\end{matrix} ] ⊗ {\tilde{v}}_{1 , 0}^{T} ( t ) \\ ⋮ \\ [ \begin{matrix}1 & {φ}_{1} ( f ) \\ 1 & - {φ}_{1} ( f )\end{matrix} ] ⊗ {\tilde{v}}_{1 , Q - 1}^{T} ( t )\end{matrix} ]$$

The proposed framework for MU-MIMO grouping and precoder calculation may be used for users 0 and 1 despite the differences in their CSI. In particular, a channel orthogonality metric may be calculated for the two UEs as

$${ρ}^{( 0 , 1 )} = \frac{1}{{N}_{f}} {\sum }_{f = 0}^{{N}_{f} - 1} {\sum }_{u = 0}^{{L}_{0} - 1} {\sum }_{v = 0}^{{L}_{1} - 1} {\vert {\tilde{h}}_{0 , u}^{H} ( f , t ) {\tilde{u}}_{1 , v}^{T} ( f , t ) \vert}^{2} ,$$

where ∥.∥ denotes the Euclidean norm of a vector, N_{f} is the total number of subbands, and ũ_{1,v}(f, t) denotes the vth row of the matrix Ũ₁(f, t). Calculating ρ^{(0,1)} uses the fact that ∥ũ_{1,v}(f, t)∥=∥\tilde{h}_{0,u}(f, t)∥=1.

The joint MU-MIMO precoder for UEs 0 and 1 may also be calculated by defining the L×M combined directional information matrix \tilde{V}(f, t) using the normalized channel estimates of UE 0 and the co-phased the per-polarization estimated eigen vectors of UE 1, i.e.,

$$\tilde{V} ( f , t ) = [ \begin{matrix}{\tilde{h}}_{0 , 0}^{T} ( f , t ) \\ ⋮ \\ {\tilde{h}}_{0 , {L}_{0} - 1}^{T} ( f , t ) \\ {\tilde{u}}_{1 , 0} ( f , t ) \\ ⋮ \\ {\tilde{u}}_{1 , {L}_{1} - 1} ( f , t )\end{matrix} ]$$

The M×L precoding matrix (in beamspace domain) for downlink transmission may designed using the MMSE design criterion using the combined channel matrix \tilde{V}(f, t). Power normalization and per-antenna power constraints are then applied. Finally, the precoder is transformed to antenna space to be used for precoding downlink transmissions to the paired users.

The performance of particular embodiments may be illustrated by the following numerical simulations. The performance of the MU-MIMO precoding algorithm is illustrated using system-level simulations. The example simulates a 5G cellular system with bandwidth 36 MHz and carrier frequency 3.5 GHz. The system operates in TDD mode where the Downlink/Uplink timeslot pattern is 3/1. The example uses a seven-site deployment scenario where each site has three cells, the inter-site distance is equal to 500 m and the UEs are dropped randomly in the simulation area. The 5G SCM Urban Macro channel model is used in this simulation. The antenna configuration at the base station is 4×8×2 configuration, i.e., M_{V}=4, M_{H}=8, and M=64 and each UE is equipped with 4 omni-directional receive antennas. The traffic model for the downlink is selected as full buffer.

As a benchmark for comparison, the example uses the MU-MIMO RAT algorithm. In this algorithm, downlink channel estimates are acquired at the base station using full-bandwidth SRS that are periodically transmitted from each UE every 6 msec. MMSE precoding is used for MU-MIMO RAT transmission using the latest channel estimates for each subband. In contrast, the algorithm described in the embodiments above uses only the channel estimates acquired from DMRS symbols within PUSCH transmissions.

Because there is no uplink traffic, PUSCH transmissions occur only when the UE is transmitting CSI reports. The reports are performed using 32 port CSI-RS configuration. The minimum time between the reception of a CSI report and the next time a request for a report is made is selected as 20 msec. Thus, the algorithm described in the embodiments above uses an amount of channel information much smaller than that used using MU-MIMO RAT.

The performance of the Eigen precoding algorithm described in the embodiments above is compared against codebook-based MU-MIMO precoding that uses the reported PMI in the CSI report to select the paired users based on the PMI distance in horizontal or vertical domain. Codebook based MU-MIMO also uses the reported PMI of the paired users to calculate the downlink MU-MIMO precoders.

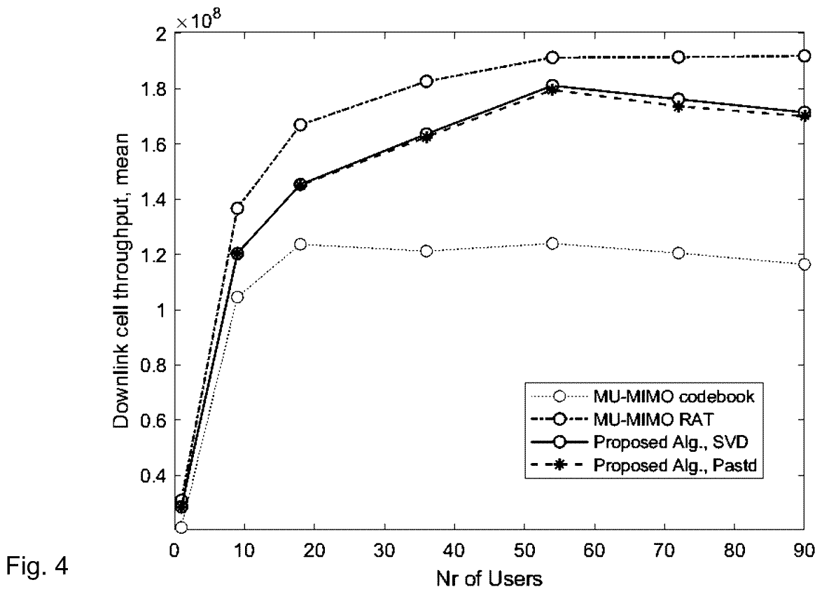

FIG. 4 is a graph illustrating the average downlink cell throughput versus the number of users in the simulation. As illustrated, particular embodiments yield significant gain in cell throughput compared to MU-MIMO codebook precoding while using the same amount of information, i.e., periodic CSI reports transmitted by the UEs. Also evident from the graph is that performance of MU-MIMO Eigen beamforming with PASTd is almost the same as using SVD. Furthermore, the graph illustrates that the performance of the algorithm described in the embodiments above is close to that of MU-MIMO RAT precoding even though MU-MIMO RAT uses more detailed CSI obtained from full bandwidth SRS transmissions.

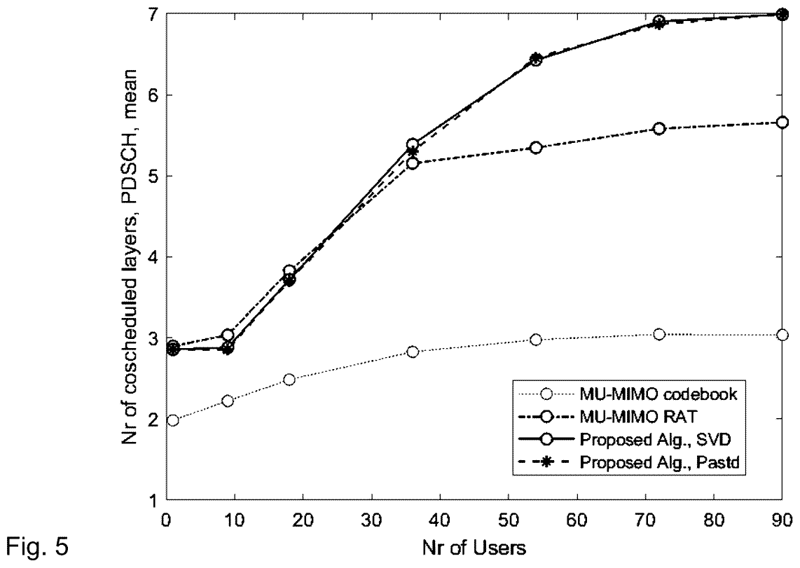

FIG. 5 is a graph illustrating the average number of MU-MIMO layers. As illustrated, the number of scheduled MU-MIMO layers of SVD and PASTd is almost the same and the algorithm described in the embodiments above as well as MU-MIMO RAT precoding can schedule more layers than MU-MIMO codebook due to the null steering capability of MMSE design criterion of both algorithms. In contrast, MU-MIMO codebook relies on user selection based on PMI distance to manage the MU-MIMO interference, which does not allow a large number of users to be co-scheduled in the same MU-MIMO transmission.

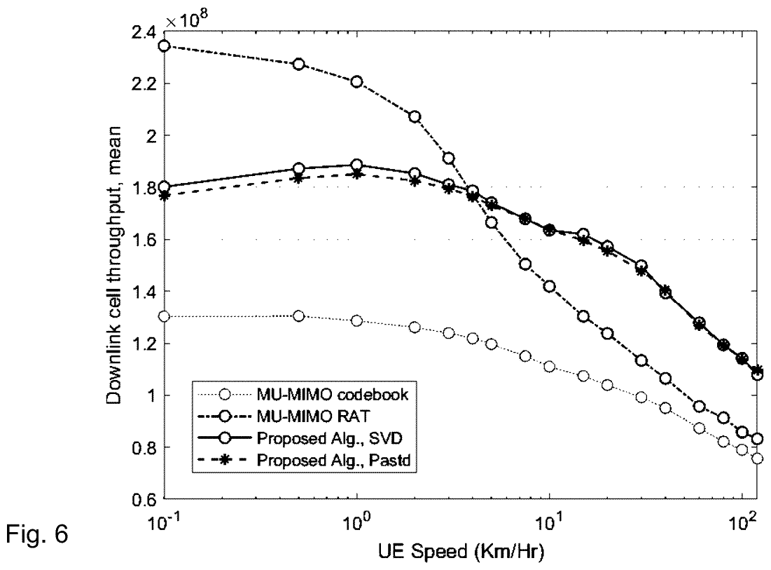

FIG. 6 is a graph illustrating the average downlink cell throughput versus the UE speed. In this simulation, 54 UEs are randomly dropped in the simulation area. As illustrated, the MU-MIMO Eigen beamforming algorithm yields higher throughput than MU-MIMO codebook at all simulated UE speeds. Furthermore, MU-MIMO Eigen beamforming may provide improved performance over MU-MIMO RAT at high mobility. This is because the proposed MU-MIMO Eigen beamforming uses the information in the covariance matrix, which changes at a slower rate with UE mobility than the instantaneous channel information used by MU-MIMO RAT.

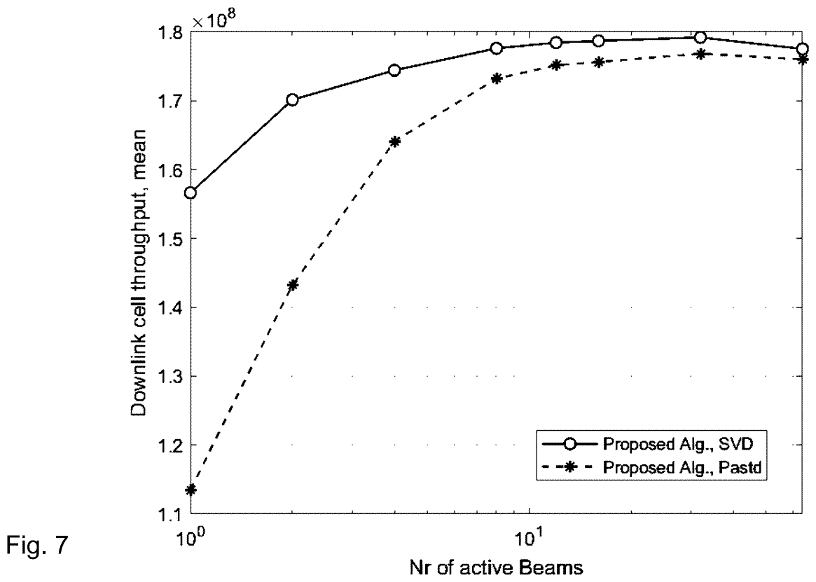

FIG. 7 is a graph illustrating the average downlink cell throughput versus the number of beamspace active beams for the algorithms described in the embodiments above. As illustrated, the proposed MU-MMIO Eigen beamforming algorithm has low sensitivity to dimension reduction. For example, for SVD-based Eigen beamforming, only four beams (out of 64 beams) can be used for beamspace reduction of channel estimates without significant degradation in throughput, whereas for PASTd-based Eigen beamforming, eight beams are needed.

The next simulation illustrates the advantages of the joint Eigen/RAT MU-MIMO precoding scheme. This simulation has 90 users that are randomly dropped in the 9-cell simulation area. The number of available SRS resources per cell is changed from 0 to 10 SRS resources.

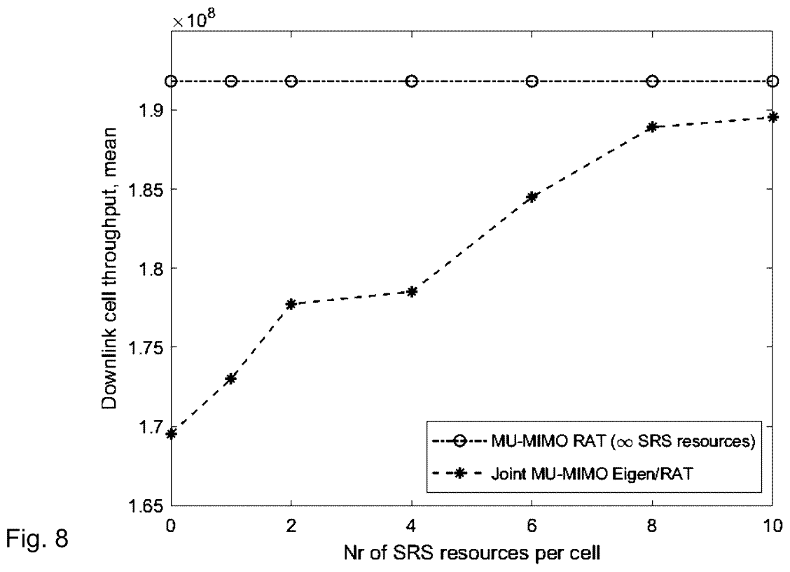

FIG. 8 is a graph illustrating the average downlink cell throughput versus the number of SRS resources. As a baseline, FIG. 8 shows the performance of the MU-MIMO RAT algorithm with infinite SRS resources. As illustrated, the performance of the proposed joint Eigen/RAT MU-MIMO precoding scheme approaches that of the RAT algorithm with infinite SRS when the number of SRS resources increases.

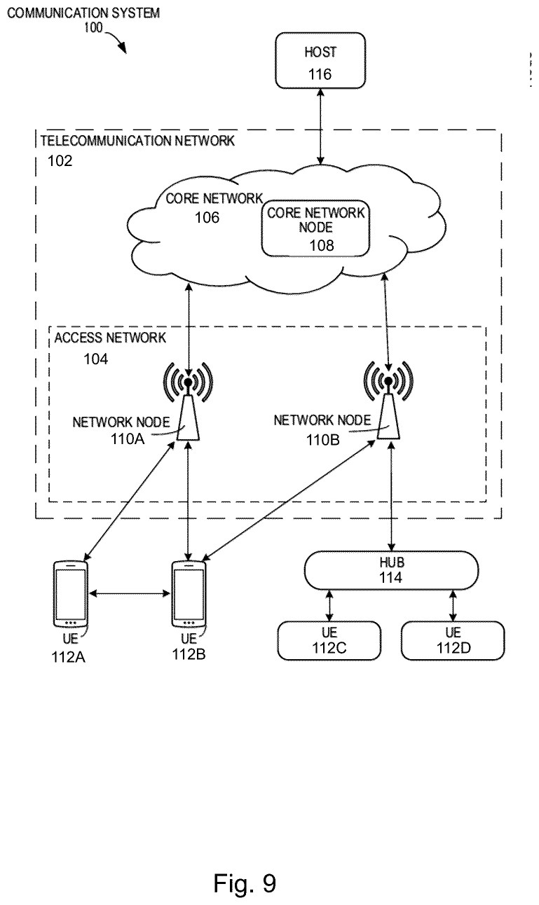

FIG. 9 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

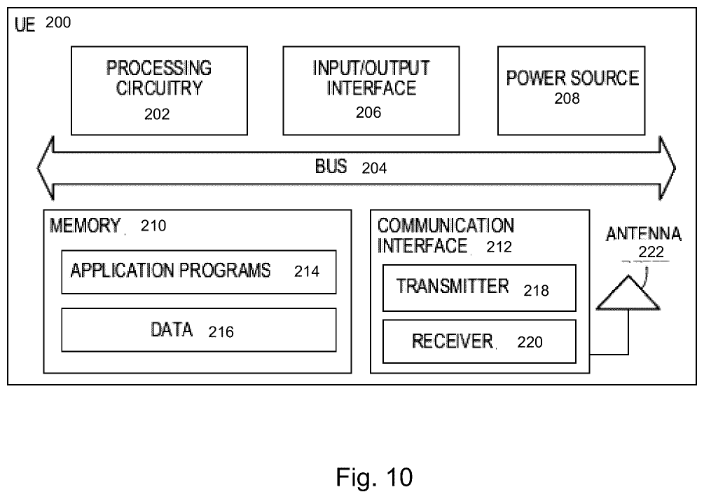

FIG. 10 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

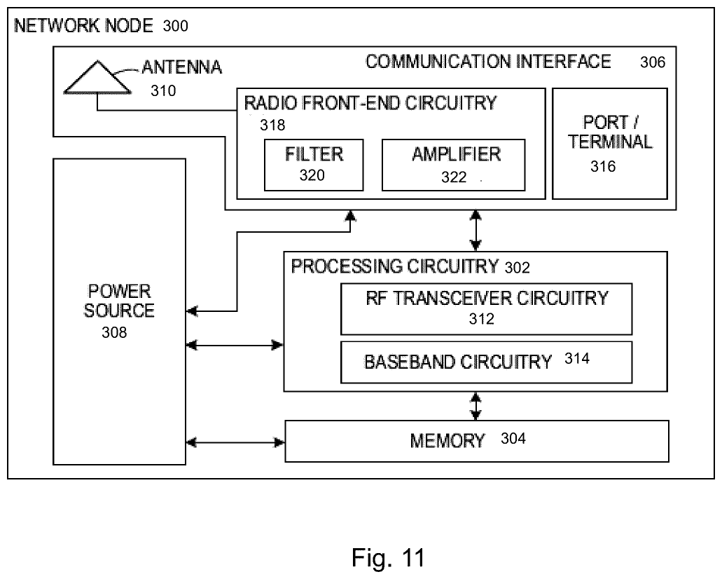

FIG. 11 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 11 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

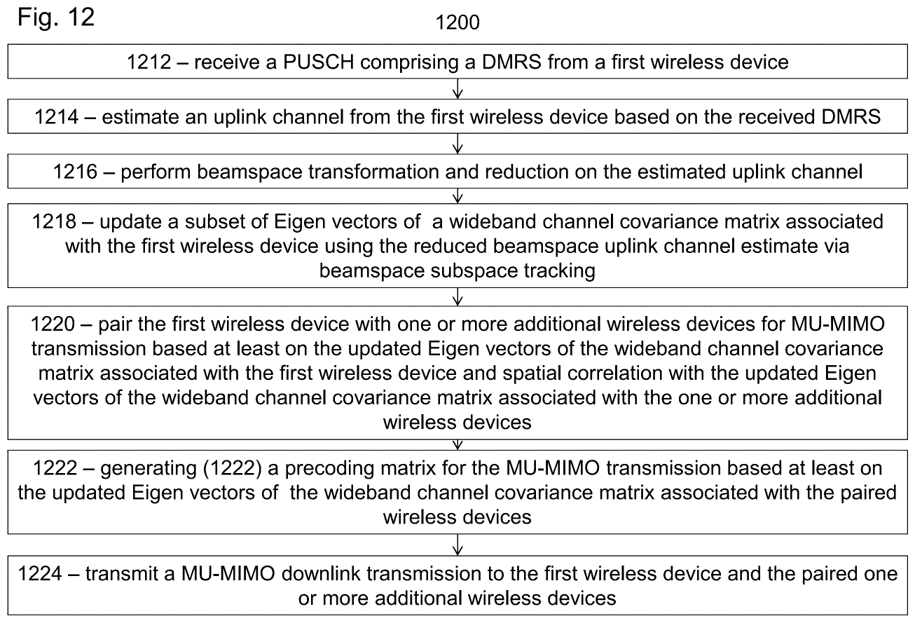

FIG. 12 is a flowchart illustrating an example method in a network node, according to certain embodiments. In particular embodiments, one or more steps of FIG. 12 may be performed by network node 300 described with respect to FIG. 11. The network node is capable of MU-MIMO transmission.

The method begins at step 1212, where the network node (e.g., network node 300) receives a PUSCH comprising a DMRS from a first wireless device. The PUSCH may comprise any uplink transmission from the wireless device, i.e., the uplink transmission may not be specifically for performing channel estimates but for general uplink traffic.

At step 1214, the network node estimates an uplink channel from the first wireless device based on the received DMRS. An advantage of using the DMRS is that it eliminates the need for detailed channel estimates and this method is not affected by the limited SRS capacity of the wireless network.

At step 1216, the network node performs beamspace transformation and reduction on the estimated uplink channel. In particular embodiments, beamspace reduction selects beams using one of a fixed number of active beam selection, a collective power in active beams selection, and a threshold-based beam selection. Beamspace transformation and reduction are described in more detail above with respect to FIG. 2.

At step 1218, the network node updates a subset of Eigen vectors of a wideband channel covariance matrix associated with the first wireless device using the reduced beamspace uplink channel estimate via beamspace subspace tracking. In particular embodiments, the beamspace subspace tracking is based on an estimated instantaneous beamspace per-polarization covariance matrix and constructing full dimension Eigen vectors via cophasing the Eigen vectors of the per polarization covariance matrix. The beamspace subspace tracking may use projection approximation subspace tracking with deflation (PASTd). The beamspace subspace tracking may further comprise orthogonalizing Eigen vectors that were updated using PASTd.

Beamspace subspace tracking and associated algorithms such as PASTd are described in more detail above with respect to FIG. 2.

At step 1220, the network node pairs the first wireless device with one or more additional wireless devices for MU-MIMO transmission based at least on the updated Eigen vectors of the wideband channel covariance matrix associated with the first wireless device and spatial correlation with the updated Eigen vectors of the wideband channel covariance matrix associated with the one or more additional wireless devices. In particular embodiments, pairing the first wireless device with one or more additional wireless devices is further based on SRS based channel estimates associated with each of the one or more additional wireless devices. A more detailed description of how to pair SRS-based estimates and Eigen vector based estimates are described in more detail above with respect to FIGS. 2 and 3. Pairing the first wireless device with one or more additional wireless devices may be further based on a transmission priority associated with each of the one or more additional wireless devices.

At step 1222, the network node may generate a precoding matrix for the MU-MIMO transmission based at least on the updated Eigen vectors of the wideband channel covariance matrix associated with the paired wireless devices. In particular embodiments, generating the precoding matrix is further based on Eigen vectors of the wideband channel covariance matrix associated with each of the one or more additional wireless devices. Generating the precoding matrix may be further based on SRS based channel estimates associated with each of the one or more additional wireless devices. A more detailed description of how to generate the precoding matrix for SRS-based estimates and Eigen vector based estimates are described in more detail above with respect to FIGS. 2 and 3.

At step 1224, the network node transmits a MU-MIMO downlink transmission to the first wireless device and the paired one or more additional wireless devices.

Modifications, additions, or omissions may be made to method 1200 of FIG. 12. Additionally, one or more steps in the method of FIG. 12 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a network node for multiple-user multiple-input multiple-output (MU-MIMO) transmission, the method comprising:
receiving a physical uplink shared channel (PUSCH) comprising a demodulation reference signal (DMRS) from a first wireless device;
estimating an uplink channel from the first wireless device based on the received DMRS;
performing beamspace transformation and reduction on the estimated uplink channel;
updating a subset of Eigen vectors of a wideband channel covariance matrix associated with the first wireless device using the reduced beamspace uplink channel estimate via beamspace subspace tracking;
pairing the first wireless device with one or more additional wireless devices for MU-MIMO transmission based at least on the updated Eigen vectors of the wideband channel covariance matrix associated with the first wireless device and spatial correlation with the updated Eigen vectors of the wideband channel covariance matrix associated with the one or more additional wireless devices; and
transmitting a MU-MIMO downlink transmission to the first wireless device and the paired one or more additional wireless devices.

2. The method of claim 1, further comprising generating a precoding matrix for the MU-MIMO transmission based at least on the updated Eigen vectors of the wideband channel covariance matrix associated with the paired wireless devices, and wherein transmitting the MU-MIMO downlink transmission uses the precoding matrix.

3. The method of claim 1, wherein beamspace reduction selects beams using one of a fixed number of active beam selection, a collective power in active beams selection, and a threshold-based beam selection.

4. The method of claim 1, wherein the beamspace subspace tracking is based on an estimated instantaneous beamspace per-polarization covariance matrix and constructing full dimension Eigen vectors via cophasing the Eigen vectors of the per polarization covariance matrix.

5. The method of claim 1, wherein the beamspace subspace tracking uses projection approximation subspace tracking with deflation (PASTd).

6. The method of claim 5, wherein the beamspace subspace tracking further comprises orthogonalizing Eigen vectors that were updated using PASTd.

7. The method of claim 1, wherein pairing the first wireless device with one or more additional wireless devices is further based on sounding reference signal (SRS) based channel estimates associated with each of the one or more additional wireless devices.

8. The method of claim 1, wherein pairing the first wireless device with one or more additional wireless devices is further based on a transmission priority associated with each of the one or more additional wireless devices.

9. The method of claim 2, wherein generating the precoding matrix is further based on Eigen vectors of the wideband channel covariance matrix associated with each of the one or more additional wireless devices.

10. The method of claim 1, wherein generating the precoding matrix is further based on sounding reference signal (SRS) based channel estimates associated with each of the one or more additional wireless devices.

11. A network node capable of multiple-user multiple-input multiple-output (MU-MIMO) transmission, the network node comprising processing circuitry operable to:
receive a physical uplink shared channel (PUSCH) comprising a demodulation reference signal (DMRS) from a first wireless device;
estimate an uplink channel from the first wireless device based on the received DMRS;
perform beamspace transformation and reduction on the estimated uplink channel;
update a subset of Eigen vectors of a wideband channel covariance matrix associated with the first wireless device using the reduced beamspace uplink channel estimate via beamspace subspace tracking;
pair the first wireless device with one or more additional wireless devices for MU-MIMO transmission based at least on the updated Eigen vectors of the wideband channel covariance matrix associated with the first wireless device and spatial correlation with the updated Eigen vectors of the wideband channel covariance matrix associated with the one or more additional wireless devices; and
transmit a MU-MIMO downlink transmission to the first wireless device and the paired one or more additional wireless devices.

12. The network node of claim 11, the processing circuitry further operable to generate a precoding matrix for the MU-MIMO transmission based at least on the updated Eigen vectors of the wideband channel covariance matrix associated with the paired wireless devices, and wherein transmitting the MU-MIMO downlink transmission uses the precoding matrix.

13. The network node of claim 11, wherein beamspace reduction selects beams using one of a fixed number of active beam selection, a collective power in active beams selection, and a threshold-based beam selection.

14. The network node of claim 11, wherein the beamspace subspace tracking is based on an estimated instantaneous beamspace per-polarization covariance matrix and constructing full dimension Eigen vectors via cophasing the Eigen vectors of the per polarization covariance matrix.

15. The network node of claim 11, wherein the beamspace subspace tracking uses projection approximation subspace tracking with deflation (PASTd).

16. The network node of claim 15, wherein the beamspace subspace tracking further comprises orthogonalizing Eigen vectors that were updated using PASTd.

17. The network node of claim 11, wherein the processing circuitry is operable to pair the first wireless device with one or more additional wireless devices further based on sounding reference signal (SRS) based channel estimates associated with each of the one or more additional wireless devices.

18. The network node of claim 11, wherein the processing circuitry is operable to pair the first wireless device with one or more additional wireless devices further based on a transmission priority associated with each of the one or more additional wireless devices.

19. The network node of claim 12, wherein the processing circuitry is operable to generate the precoding matrix further based on Eigen vectors of the wideband channel covariance matrix associated with each of the one or more additional wireless devices.

20. The network node of claim 11, wherein the processing circuitry is operable to generate the precoding matrix further based on sounding reference signal (SRS) based channel estimates associated with each of the one or more additional wireless devices.
